(19) United States
(12) Patent Application Publication
(10) Pub. No.: US 2014/0284832 A1
(43) Pub. Date: Sep. 25, 2014

(54) System and Method for Manufacturing a Three-Dimensional Object from Freely Formed Three-Dimensional Curves

(71) Applicants: Petr Novikov, Moscow (RU); Sasa Jokic, Belgrade (RS)

(72) Inventors: Petr Novikov, Moscow (RU); Sasa Jokic, Belgrade (RS)

(21) Appl. No.: 13/894,056

(22) Filed: May 14, 2013

Related U.S. Application Data
(60) Provisional application No. 61/804,755, filed on Mar. 25, 2013.

(51) Int. Cl. B29C 67/00

(52) U.S. Cl. CPC B29C 67/0088
USPC 264/40.1; 425/150

(57) ABSTRACT

A three-dimensional object is manufactured by forming a series of three-dimensional formed curves of extruded material that together comprise the geometry of the surface of the object. The material is extruded from a nozzle that is positioned by a robotic arm under the control of a robotic controller. A computer that has a definition of the geometric surface generates commands to the robotic controller to cause it to sequentially form the series of formed curves that the computer calculates comprise the surface geometry.

### PRIORITY CLAIM

This application claims priority to provisional U.S. Pat. App. No. 61/804,755, filed on Mar. 25, 2013 and incorporates that application by reference for all that it teaches.

### FIELD OF INVENTION

This invention relates to techniques for forming three-dimensional (3D) objects; more particularly, it relates to techniques for use in Rapid Prototyping and Manufacturing (RP&M) Systems

### BACKGROUND

There are several prior-art devices and methods for additive manufacturing that are used to form three-dimensional objects under the control of a computer program. Three of the most well-known methods are FDM (Fused Deposition Modeling), SLS (Selective Laser Sintering), SLA (Stereolithography) and Powerbed and inkjet head 3D printing. These methods of forming three-dimensional objects share one very important characteristic: they all produce three-dimensional objects from 3D computer data by creating a set of thin two-dimensional cross-sectional slices of the object and then forming the object by laying the cross-sections in an additive set of adhered laminae. These laminae are sometimes called object cross-sections, layers of structure, object layers, layers of the object, or simply layers (if the context makes it clear that solidified structure of appropriate shape is being referred to). The prior-art laminae are typically substantially planar rather than three-dimensional.

The above mentioned methods share other limitations, three of which are: the necessity of a support structure under hanging laminae, the inability of forming objects on a special working surface plane and the requirement of mutual adherence of the cross-sectional laminae.

Hanging laminae are the laminae that are not located over previous laminae or special working surface which require presence of the support structure below them in order to lean on something. In the cases of SLS, Powerbed and inkjet head 3D printing, this problem is usually solved by the presence of preceding layers of material that was used to create previous laminae. In the cases of FDM or SLA methods, this problem is usually solved by laying support laminae that are usually calculated by the software that controls the process. This results in additional structures connected to the final object which require post processing of the final object for example, filing or sanding. This post processing can sometimes damage the 3-D object.

Most of these methods require a special horizontal working surface for the forming of objects, the objects can not be formed on working surfaces with irregular height, and can not be formed on vertical working surfaces due to the force of gravity. These methods cannot form 3-D objects on such surfaces like walls, ceilings and unsmooth or irregular surfaces. These prior-art methods also require maximal mutual adherence of the laminae for a better result, due to the substantially two-dimensional structure of the laminae. Separation of neighboring laminae may result in weakness of the object and may be considered as a defect. That means that only solid surfaces can be created by these methods.

While these methods are good for forming objects of good qualities inside of the designated machines, they are not adequate for forming objects outside of the machines on unprepared settings and forming objects that don't have support underneath them. For example with any of these technologies it would be impossible to form a door handle on the vertical surface of a door or form a chandelier on the surface of the ceiling.

There is a need for a method and system whereby the 3-D objects are formed on any given working surface independently of its inclination and smoothness, and without a need of additional support structures. Further, there is a need for a method that allows the manufacture of three-dimensional curves instead of two-dimensional laminae as in conventional additive manufacturing methods. The present invention is directed towards providing such a method and system.

### SUMMARY OF THE INVENTION

This invention centers around the implementation of a fast-curing two-component thermosetting polymer, preferably polyurethane, as a base material in the additive manufacturing process. The invention allows forming three-dimensional objects formed by three-dimensional curves.

The source material is a flowable material which hardens due to the chemical reaction between two types of source components triggered by the mixing of the components preferably in a static mixer. The source components are extruded by preferably a constant-rate extruder through a nozzle, with such an extrusion speed that the solidification occurs a short time period and distance after the mixed material is extruded from the print head. The size and shape of the nozzle and the aperture of the print head may be varied according to the users needs. Control features preferably include the ability to increase or decrease the speed of the extrusion of the source components in order to increase or decrease the thickness of the formed curve.

In another embodiment of the invention, dye can be added to the mixed material by injecting it into the nozzle to change the color of the extruded material. In another embodiment, one or more heaters provide a constant flow of hot air, preferably of 190 degrees Celsius (374 degrees Fahrenheit) directed at the formed curve as it emerges from the nozzle, preferably at a distance equal or more than one print head aperture width from the print head in order to provide faster solidification of the material.

The nozzle is preferably positioned in space by a robotic arm. In the preferred embodiment, the arm has six or more axes of freedom. The path of the nozzle and its orientation is input to the controller of the robotic arm by the output of a computer program. A computer program interprets an object design file and then generates robotic arm control signals based on the computer modeled design. This rendering process includes determining a pre-determined series of three-dimensional curves that will comprise the object. The speed of the nozzle movement along the input path is defined according to the curing speed of the chosen source material in such way that the material extruded from the print head is completely cured by the time the print head moves more than the distance equal to the width of the print head aperture from it. The control features preferably include a possibility to increase or decrease the speed of the nozzle movement along the input path in order to decrease or increase the thickness of the printed three-dimensional curve.

The process of forming the desired 3-D object starts with positioning the nozzle over the chosen working surface such that the print head of the nozzle is located preferably at the distance equal to the width of the print head aperture away from the starting point of the first three-dimensional curve on the chosen working surface. The extrusion of source material components through the mixing part of the nozzle begins and mixed material is extruded through the nozzle print head. As soon as mixed material connects to the starting point of the first predetermined curve on the chosen working surface the nozzle starts moving along the first curve path with the appropriate speed. When the print head of the nozzle reaches the end point of the first curve path the extrusion is stopped.

The nozzle is then relocated to the next starting point, preferably at the distance equal to the width of the print head aperture away from the starting point of the first curve path on the chosen working surface. The extrusion of source material components through the mixing part of the nozzle restarts and mixed material is extruded through the nozzle print head. As soon as mixed material connects to the starting point of the second predetermined curve path on the chosen working surface the nozzle starts moving along the second curve path preferably rotating relative to the print head in three planes, including up to 45 degrees in each plane in order to avoid collision between the nozzle and the first formed curve. When the print head of the nozzle reaches the end point of the second formed curve the extrusion is stopped. The action is repeated until all of the three-dimensional curves forming the desired three-dimensional object are produced.

The present invention advances the art of forming three-dimensional (3D) objects by allowing their formation by a series of three-dimensional curves. In addition it allows a starting surface of any inclination as a working surface for forming three-dimensional objects. Moreover it allows forming three-dimensional objects without need of additional support material which is required by most of existing methods. As well it is suitable to be used in zero gravity because the process is not affected by the lack of the force of gravity.

### BRIEF DESCRIPTION OF THE DRAWINGS

A clear understanding of the key features of the invention summarized above may be had by reference to the appended drawings, which illustrate the method of the invention, although it will be understood that such drawings depict preferred embodiments of the invention and, therefore, are not to be considered as limiting its scope with regard to other embodiments which the invention is capable of contemplating. Accordingly:

FIG. 1 is a perspective view showing the preferred technical setting for the present invention.

FIG. 2 (A) is a section view showing the structure of the nozzle.

FIG. 2 (B) is an exploded perspective view showing the structure of the nozzle.

FIG. 3 is a section view of the nozzle schematically showing the mixing process of the source material components and the curve forming process.

FIG. 4 (A) is a side view showing the process of forming a first curve with the orientation of the nozzle.

FIG. 4 (B) is a side view showing the process of forming a second curve.

FIG. 5 (A) is a perspective view showing an example input shape for a 3-D object.

FIGS. 5 (B), 5 (C), 5 (D) are perspective views showing different versions of possible three-dimensional renderings from the input shape shown in the FIG. 5 (A) using the formed curves.

FIGS. 6 (A), 6 (B), 6 (C), 6 (D) are perspective views showing the forming process of the three-dimensional object from the input shape shown in the FIG. 5 (A).

FIG. 6 (A) shows the forming process of the first curve.

FIG. 6 (B) shows the forming process of the third curve.

FIG. 6 (C) shows the forming process of the 18th curve.

FIG. 6 (D) shows the forming process of the last curve.

FIG. 7 (A) is a side view showing the process of forming the curve with a starting point on the bottom side of a horizontal working surface.

FIG. 7 (B) is a side view showing the process of forming the curve with a starting point on the a working surface rotated forty five degrees relative to the ground.

FIG. 7 (C) is a side view showing the process of forming the curve with a starting point on a vertical working surface.

FIGS. 8 (A), 8 (B), 8 (C) are side views showing formed curves with various thicknesses caused by the change of the extrusion speed.

FIGS. 8 (D), 8 (E), 8 (F) are side views showing formed curves with various thicknesses caused by the change of the speed of the movement of the nozzle.

FIG. 9 is a side view showing a formed curve with varying thickness caused by the change of the extrusion speed and the change of the speed of the movement of the nozzle.

FIG. 10 is a section view of the nozzle schematically showing the mixing process of the source material components and optional dye and showing the curve forming process.

FIG. 11 (A) is a side view showing the process of forming the curve with the use of optional heaters.

FIG. 11 (B) is a perspective view showing the process of forming the curve with the use of optional heaters.

### REFERENCE NUMERALS IN THE DRAWINGS

The following reference numbers are labeled with the component names referenced in the specification.
1 Nozzle
2 Robotic Arm
3 Pipe
4 Constant-rate extruder
5 Heater
6 Static mixer
7 Connector
8 Component A inlet
9 Component B inlet
10 Dye inlet
11 Print head
12 Source Material Component A
13 Source Material Component B
14 Formed curve
15 Cured source material
16 Working surface
17 Digital input shape
18 Curve path
19 Curve vector
20 Deviated curve vector
21 Dye
22 Heat flow
23 Starting point
24 End point
25 Nozzle axis

### DETAILED DESCRIPTION OF INVENTION

The present invention allows forming three-dimensional objects by forming three-dimensional curves.

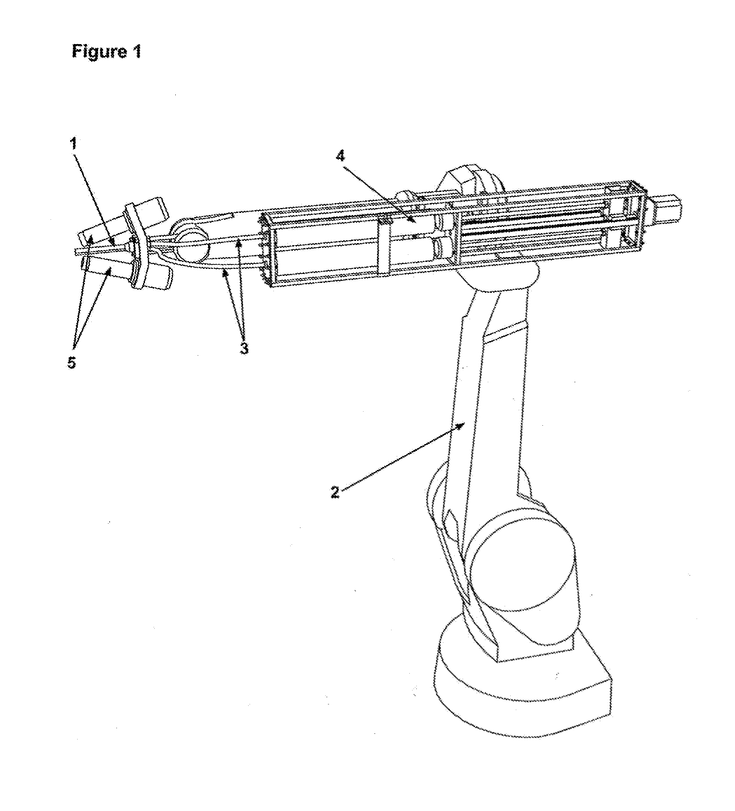

Referring to FIG. 1, showing the preferred technical setting for the present invention. The nozzle 1 is mounted preferably on the tool base of the robotic arm 2 with preferably six or more axes of freedom and connected with pipes 3 to a preferably constant-rate extruder 4, optional heaters 5 are mounted on the tool base of the robotic arm.

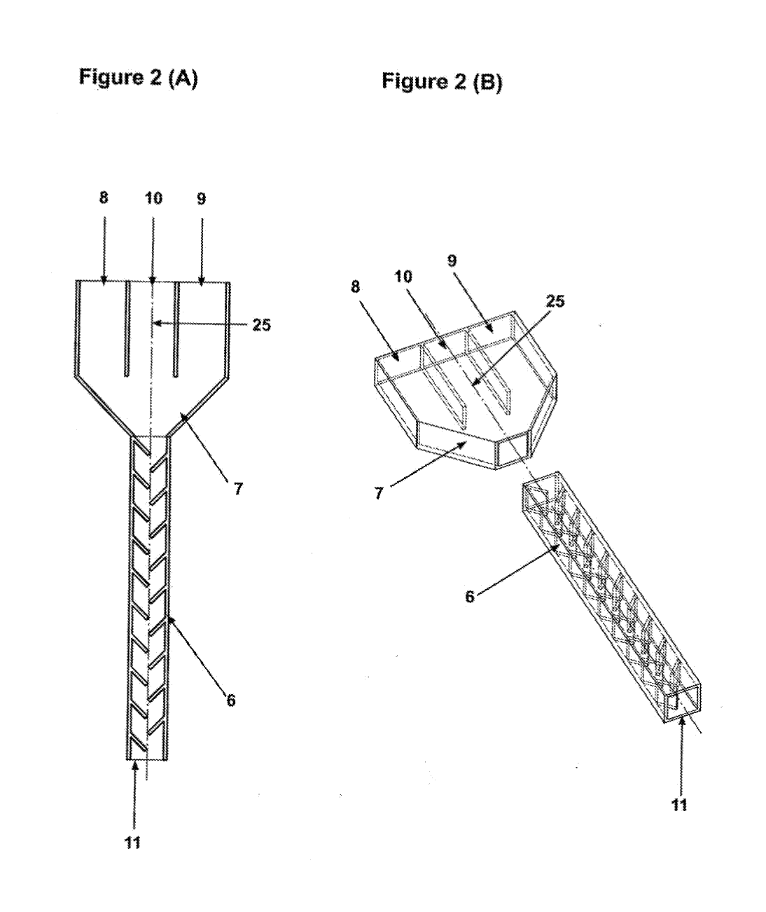

FIGS. 2 (A) and 2 (B) depict the structure of the construction of the nozzle. The nozzle consists of the nozzle connector 7 which has source material component A inlet 8, source material component B inlet 9 that are connected preferably through flexible pipes to preferably constant-rate extruder 4 with adjustable speed of extrusion shown in the FIG. 1. The nozzle connector 7 also has a dye inlet 10. The nozzle connector 7 connects to a static mixer 6 that provides mixing of source material component A, source material component B and dye before they are extruded through the print head 11. The size of the nozzle and the aperture of the print head 11 may be varied according to the users needs. If the user needs high definition of the formed object and the thickness of the formed three-dimensional curve needs to be small, a small nozzle may be used with the aperture of the print head 11 up to 0.03 inch. In case user needs thick three-dimensional curves a nozzle with the print head 11 aperture of ½ inch can be installed. In addition, the cross-sectional shape of the formed curve can be varied by changing the shape of the aperture, for example from a circle to a square. The speed of the nozzle is adjusted to match the rate of the extrusion of the source material. As a result, the composition of the source materials or the temperature of the air blown on the extruded material is selected so that at the desired speed of the nozzle, the mixed source material exits the nozzle aperture in a substantially cured state. If the rate of extrusion and nozzle speed is too fast, the formed curve may collapse. If the rate of extrusion is too slow, the material may solidify inside the nozzle.

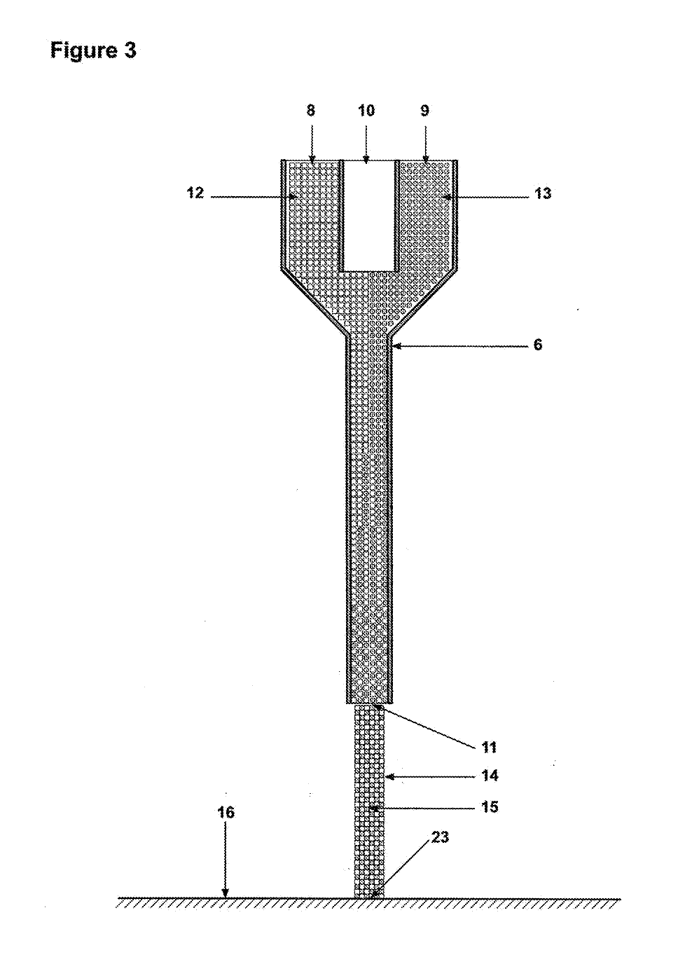

In FIG. 3 a section view of the nozzle 1 is depicted showing the mixing process of component A 12 and component B 13 and showing the formed curve 14 (the section of the static mixer 6 is simplified for better visualization of the mixing process). Source material component A 12 and Component B 13 are injected to in the nozzle 1 through component A inlet 8 and component B inlet 9 accordingly. Component A 12 and component B 13 are mixed in the static mixer 6 resulting in a chemical reaction that causes curing of the mixture. As the curing mixture is extruded through the print head 11, it forms the curve 14. Component A 12 and Component B 13 are liquid flowable materials preferably Isocyanate and Polyol.

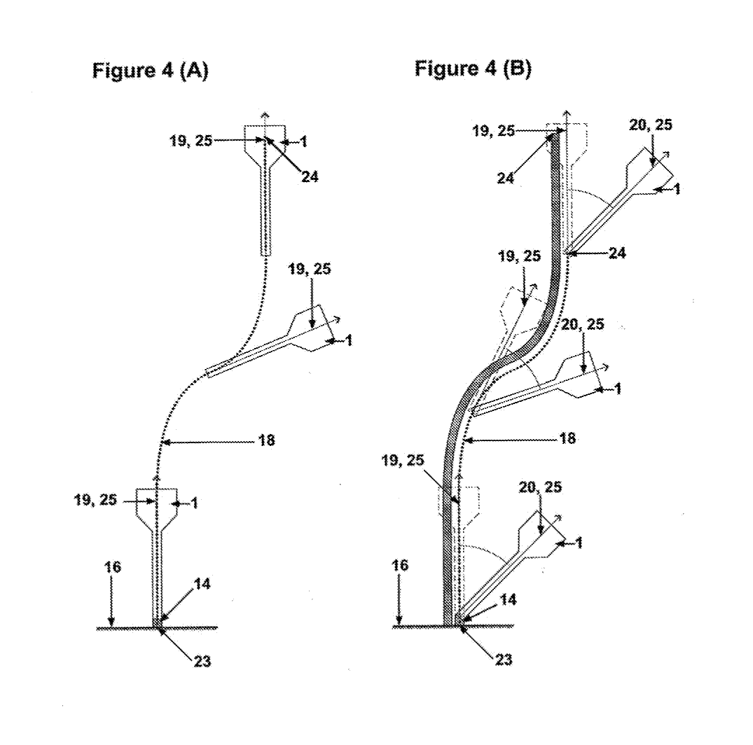

FIG. 4 (A) shows the process forming of the first formed curve 14. The nozzle 1 is positioned over the working surface 16 such that the print head 11 of the nozzle 1 is located preferably at the distance equal to the width of the print head aperture away from the starting point 23 of the first curve path 18 on the working surface 16. The nozzle 1 is preferably rotated in such manner that the axis 25 of the nozzle 1 coincides with the vector 19 of the curve path 18 at the starting point 23 of the first curve path 18. The extrusion of component A, component B and optional dye through the nozzle 1 begins, component A, component B and optional dye 21 are mixed in the static mixer causing curing chemical reaction, mixed material is extruded through the print head 11. When mixed material connects to the starting point 23 of the first curve path 18 on working surface 16 the nozzle 1 starts moving along the first curve path 18 moved preferably by the robotic arm. While moved along the curve path 18 the nozzle 1 is preferably rotated in such manner that the axis 25 of the nozzle 1 coincides with the vector 19 of the curve path 18 at the position of the print head 11. When the print head 11 of the nozzle 1 reaches the end point 24 of the first curve path 18 the extrusion is stopped. The first formed curve is thereby completed.

FIG. 4 (B) shows the process of forming of the second formed curve 14. The nozzle 1 is positioned over the working surface 16 such that the print head 11 of the nozzle 1 is located preferably at the distance equal to the width of the print head aperture away from the starting point 23 of the first curve path 18 on the working surface 16. The nozzle 1 is preferably rotated in such manner that the axis 25 of the nozzle 1 coincides with the vector 19 of the curve path 18 at the starting point 23 of the second curve path 18. To avoid collision of the nozzle 1 with previously formed curves, the nozzle 1 can be rotated in such manner that the axis 25 of the nozzle 1 deviates from the vector 19 of the curve path 18 at the starting point 23 of the second curve path 18 up to forty five degrees. The extrusion of component A, component B and optional dye through the nozzle 1 begins, component A, component B and optional dye are mixed in the static mixer causing the curing chemical reaction, mixed material is extruded through the print head 11. When mixed material connects to the starting point 23 of the second curve path 18 on working surface 16 the nozzle 1 starts moving along the second curve path 18 moved preferably by the robotic arm. While moved along the curve path 18 the nozzle 1 is preferably rotated in such manner that the axis 25 of the nozzle 1 coincides with the vector 19 of the curve path 18 at the position of the print head 11. To avoid collision of the nozzle 1 with previously formed curves the nozzle 1 can be rotated so the axis 25 of the nozzle 1 deviates from the vector 19 of the curve path 18 at the position of the print head 11 up to forty five degrees. When the print head 11 of the nozzle 1 reaches the end point 24 of the second input path 18 the extrusion is stopped. The second formed curve is thereby completed.

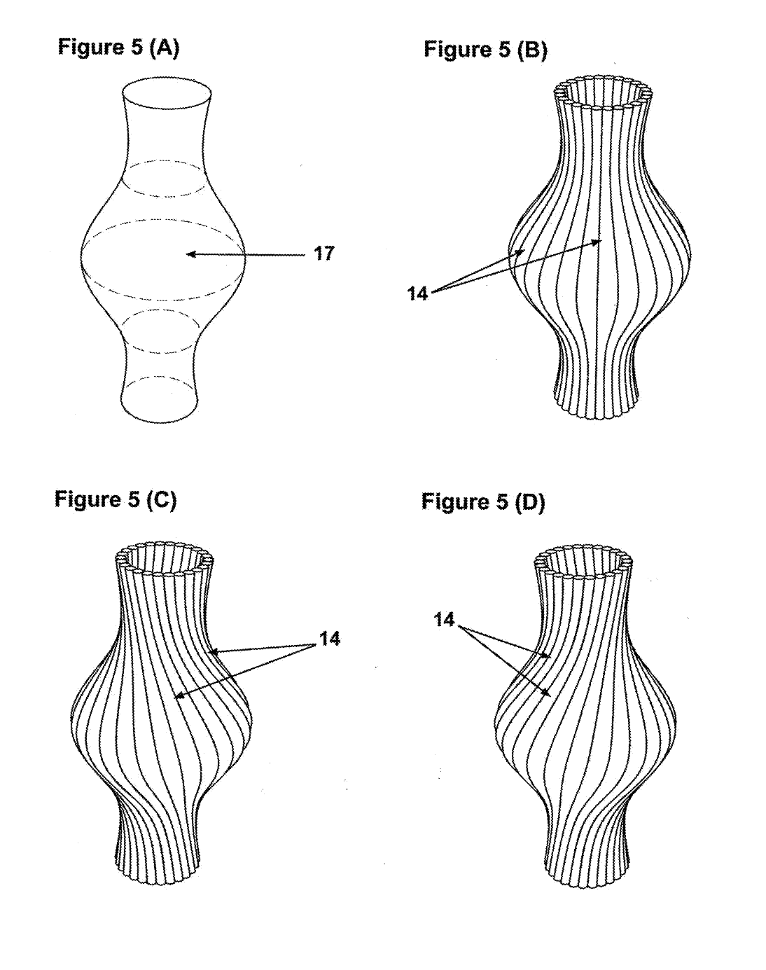

FIG. 5 (A) is a perspective view showing possible digital input shape 17 that preferably can be designed in a 3D CAD software by the user and the resulting data used by the robotic arm 2 controller. FIG. 5 (B) shows the digital input shape 17 shown in the FIG. 5 (A) formed by vertical curves 14. FIG. 5 (C) shows the digital input shape 17 shown in the FIG. 5 (A) formed by curves 14 shifting clockwise relative to the center of the formed shape. FIG. 5 (C) shows the digital input shape 17 shown in the FIG. 5 (A) formed by curves 14 shifting counterclockwise relative to the center of the formed shape.

The 3D CAD software receives input from the user via a typical user interface that permits the user to design a 3D object. The CAD software essentially compiles the 3D object design into a set of pre-determined curve paths that each have a start point, an end point and a vector for each point along the path of the curve that points to the next point. The software calculates the curve paths by relying on a specified thickness of the formed curve and other parameters, including the orientation of any twisting of the curve paths that may be specified. The output of the software is rendering information that is input into a controller module that controls the robotic arm and the extrusion equipment. The controller module receives a list of curve paths and then executes the creation of the formed curves by working down the list from the first curve path to the last.

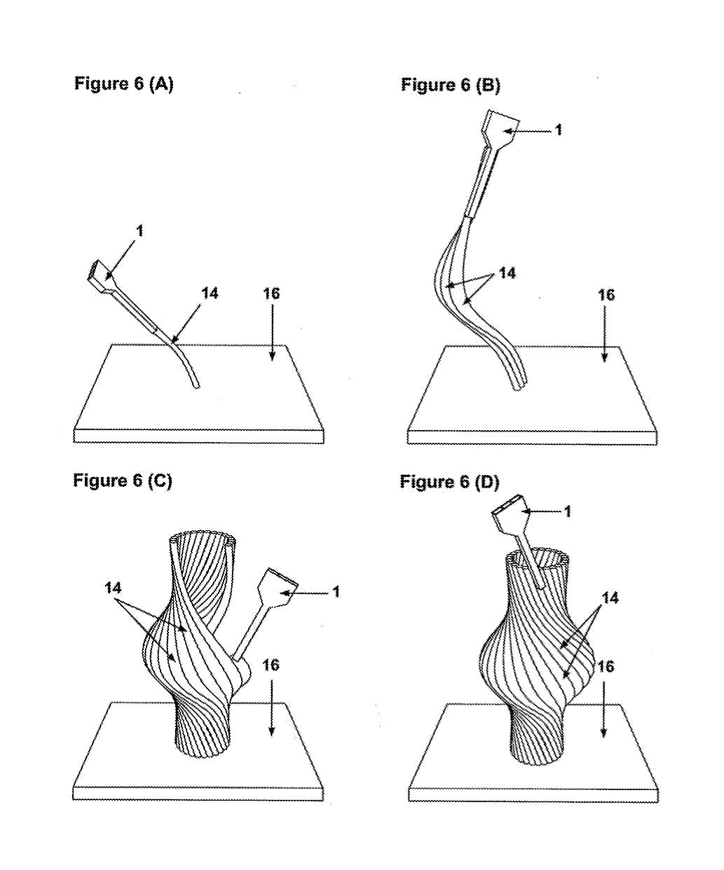

FIGS. 6 (A), 6 (B), 6 (C) and 6 (D) illustrate the process of forming the shape shown in the FIG. 5 (C). FIG. 6 (A) shows forming of the first formed curve 14 on the working surface 16. FIG. 6 (B) shows forming of the third formed curve 14 on the working surface 16. FIG. 6 (C) shows forming of the 18th curve 14 on the working surface 16. FIG. 6 (D) shows forming of the last formed curve 14 on the working surface 16.

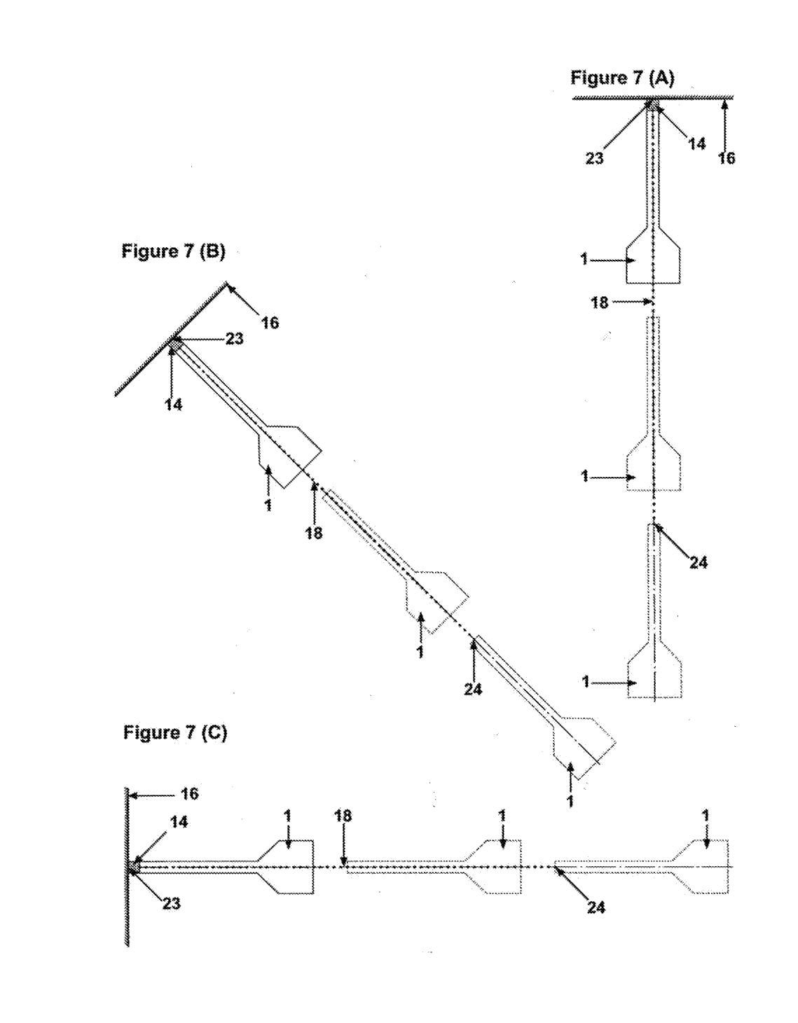

FIG. 7 (A) is a side view showing the process of forming the curve 14 with a starting point 23 on the bottom side of horizontal working surface 16. The curve 14 is formed with the method described in the FIG. 4 (A) by moving nozzle 1 along the input path 18 to the end point 24 while the mixed material is extruded. Because the mixed material that is extruded from the print-head 11 is cured the formed curve 14 is not significantly deformed by gravity.

FIG. 7 (B) is a side view showing the process of forming the curve 14 with a starting point 23 on the a working surface 16 rotated forty five degrees relative to the ground. The curve 14 is formed with the method described in the FIG. 4 (A) by moving nozzle 1 along the curve path 18 to the end point 24 while the mixed material is extruded. Because the mixed material that is extruded from the print-head 11 is cured the formed curve 14 is not significantly deformed by gravity.

FIG. 7 (C) is a side view showing the process of forming the curve 14 with a starting point 23 on the vertical working surface 16 by moving nozzle 1 along the curve path 18 to the end point 24 while the mixed material is extruded. The formed curve 14 is formed with the method described in the FIG. 4 (A). Because the mixed material that is extruded from the print-head 11 is cured the formed curve 14 is not significantly deformed by gravity.

FIGS. 7 (A), 7 (B) and 7 (C) illustrate that present method allows forming curves on working surfaces 16 rotated by any given angle.

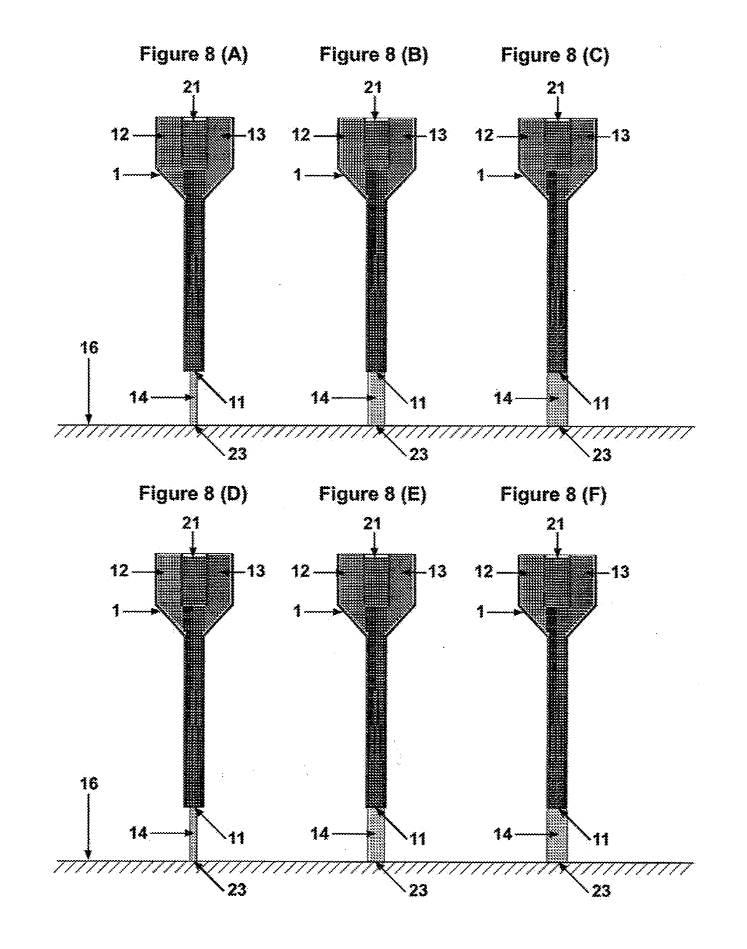

FIGS. 8 (A), 8 (B) and 8 (C) are side views showing formed curves 14 with various thicknesses caused by the change of the extrusion speed. The preferred normal speed of extrusion may vary due to different print head 11 size, different choice of component A 12 and component B 13 and other user defined criterias. But normal extrusion speed preferably should be such that when component A 12, component B 13 and dye 21 are extruded through the static mixer the chemical reaction cures the mixed material when it passes through the print head 11. The thickness of the formed curve is called normal if it is equal to the aperture of the print head. Control features preferably include a possibility to increase or decrease the normal speed of the extrusion in order to increase or decrease the thickness of the formed curve. In the FIG. 8 (A) the curve 14 was formed with half of the normal extrusion speed resulting in reduced thickness comparing to the normal thickness. In the FIG. 8 (B) the curve 14 was formed with the normal extrusion speed resulting in normal thickness. In the FIG. 8 (C) the curve 14 was formed with double of the normal extrusion speed resulting in increased thickness comparing to the normal thickness.

FIGS. 8 (D), 8 (E) and 8 (F) are side views showing formed curves 14 with various thicknesses caused by the change of the movement speed of the nozzle 1. The preferred movement speed of the nozzle 1 may vary due to different print head 11 size, different choice of component A 12 and component B 13 and other user defined criterias. But normal movement speed of the nozzle 1 preferably should be such that when the curve 14 is being formed with normal extrusion speed the cross-section of the formed curve is substantially equal to the aperture of the print head 11. Control features preferably include a possibility to increase or decrease the normal movement speed of the nozzle 1 in order to decrease or increase the thickness of the formed curve 14.

The curve 14 shown in the FIG. 8 (D) was formed with double of the normal movement speed of the nozzle 1 resulting in reduced thickness comparing to the normal thickness. The curve 14 shown in the FIG. 8 (E) was formed with the normal movement speed of the nozzle 1 resulting in normal thickness. The curve 14 shown in the FIG. 8 (F) was formed with half of the normal movement speed of the nozzle 1 resulting in increased thickness comparing to the normal thickness.

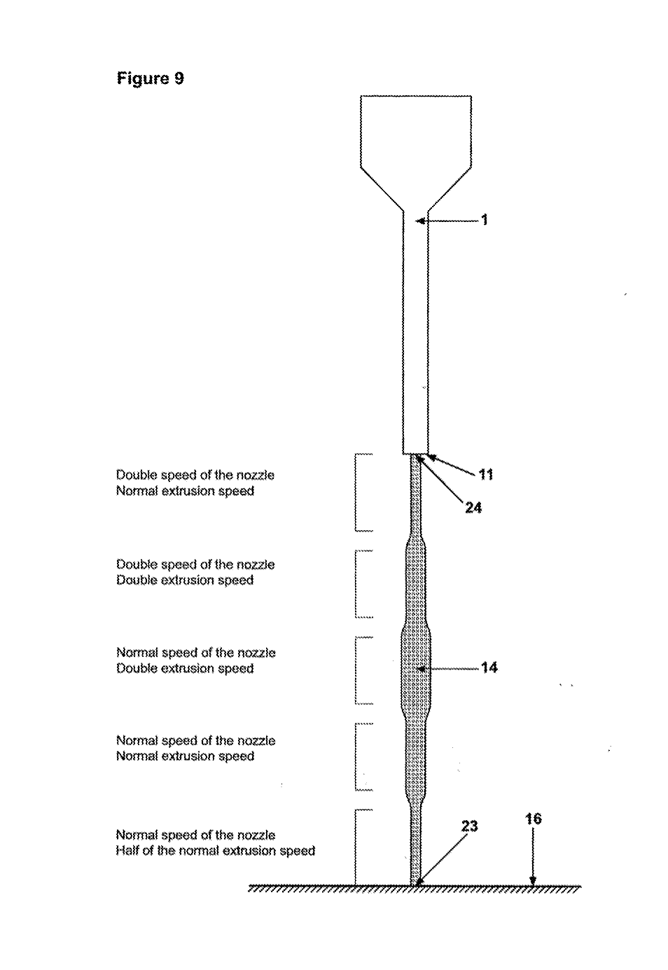

FIG. 9 is a side view showing a formed curve 14 with varying thickness caused by the change of the extrusion speed and the change of the speed of the movement of the nozzle 1. The curve 14 is formed with the method described in the FIG. 4 (A) by moving nozzle 1 along the input path from the starting point 23 to the end point 24 while the mixed material is extruded but the extrusion speed and speed of the movement of the nozzle 1 were varied. FIG. 9 illustrates that by varying extrusion speed and speed of the movement of the nozzle one curve 14 can have different thickness in different parts of the curve 14.

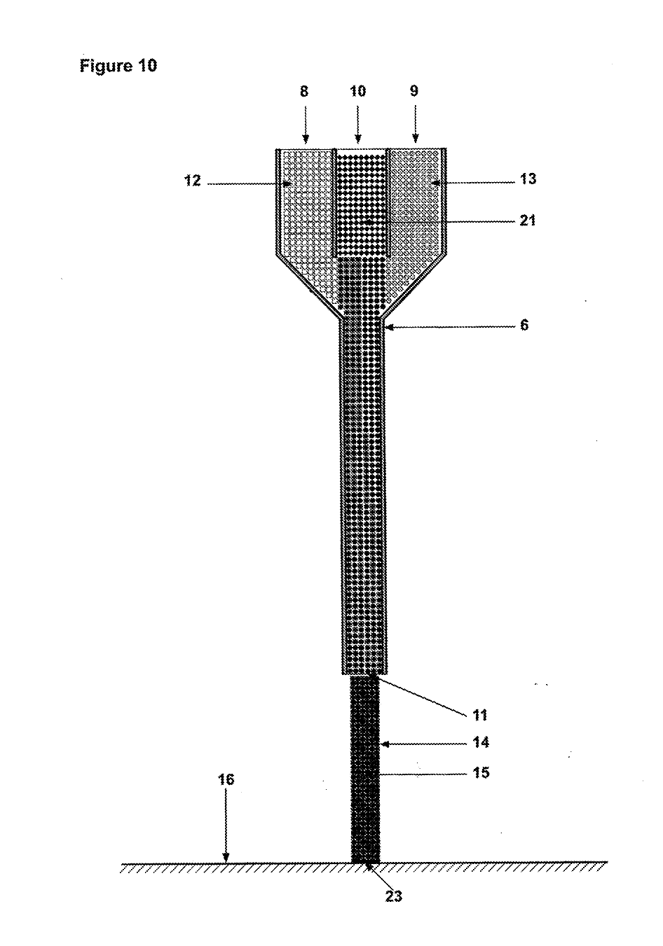

FIG. 10 is a section view of the nozzle 1 schematically showing the mixing process of component A 12, component B 13 and dye 21 and showing the curve 14 forming process (the section of the static mixer 6 is simplified for better visualization of the mixing process). Component A 12 and Component B 13 and dye 21 are injected in the nozzle 1 through component A inlet 8 and component B inlet 9 and dye inlet 10 accordingly. Component A 12 and component B 13 and dye 21 are mixed in the static mixer 6 resulting in a chemical reaction that causes curing of the mixture, the mixture is also colored by the dye 21, as the mixture is extruded through the print head 11 it forms curve 14 that has the color of the dye 21. This option allows the user to choose and change the color of the formed curve 14.

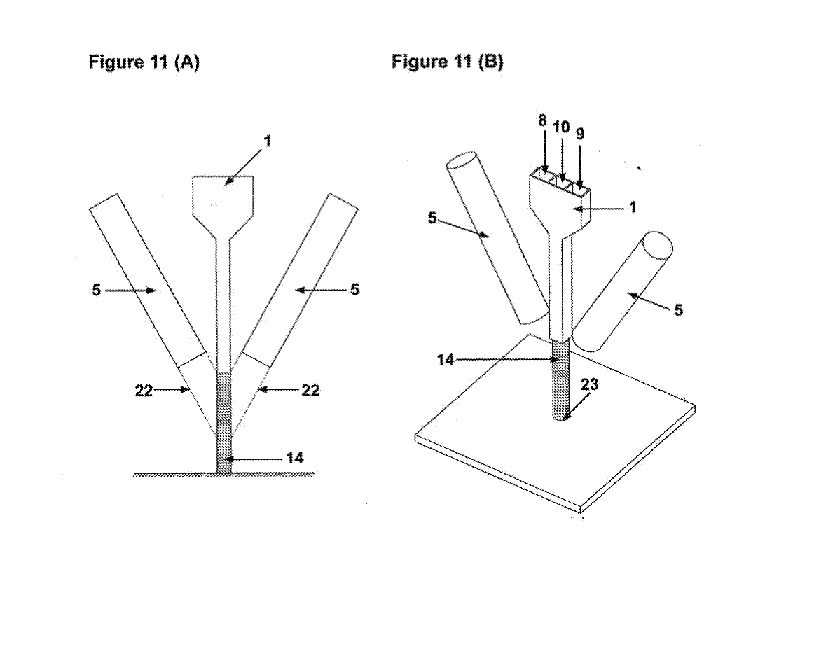

FIG. 11 (A) is a side view showing the process of forming the curve 14 with the use of optional heaters 5. FIG. 11 (B) is a perspective view showing the process of forming the curve 14 with the use of optional heaters 5. Attaching the heaters 5 increases the speed of the curing process of the mixed material. The heaters 5 preferably provide a constant flow 22 of hot air, preferably of 190 degrees Celsius (374 degrees Fahrenheit) directed at the formed curve at the distance equal or more than one print head aperture width from the print head 1 of the formed curve 14.

1. A system for forming a three dimensional object with a three dimensional geometric surface comprising:
A nozzle with an outlet aperture adapted to emit a source material from the aperture;
A positioning module adapted to position the nozzle in response to a positioning controller output, where the positioning controller is adapted to receive commands comprised of parameters defining at least one three dimensional curve paths, said at least one curve paths comprising the geometric surface, said positioning controller output being operatively connected to control the position of the nozzle by means of the positioning module.

2. The system of claim 1 where the source material is a mixture of a first component and a second component, said first and second components selected so that the combined material cures when they are mixed.

3. The system of claim 2 where the nozzle is comprised of a static mixer that mixes the first and second components in order to cause the material to cure while it is emitted.

4. The system of claim 1 further comprising a computer design system that is adapted to calculate a plurality of curve paths that comprise the surface of a pre-determined geometric surface, said design system operatively connected to the positioning controller in order to deliver to it parameters comprising the plurality of curve paths.

5. The system of claim 4 further comprising a design module adapted to receive commands from a user in order to define the predetermined geometric surface and to cause the generation of the parameters comprising the plurality of curve paths.

6. The system of claim 1 further where the positioning controller is adapted to move the nozzle along the at least one curve path as a result of moving the positioning module while the system causes the emission of the material from the nozzle.

7. The system of claim 6 where the positioning controller is further adapted to cause the rate of emission of the emitted material to cause the curing of the material to occur substantially exterior to and proximate to the aperture of the nozzle.

8. The system of claim 1 further comprising a heating module adapted to deliver heat to the material at an area exterior to the nozzle aperture in order to heat the emitted material.

9. The system of claim 1 further comprising an extruder adapted to deliver the material to the nozzle.

10. The system of claim 1 further comprising a material delivery module adapted to cause the rate of emission of the material from the nozzle to cause the material to cure in a region proximate and exterior to the aperture.

11. A method of manufacturing a 3D object with a surface geometry defined by a set of curve paths comprising:
receiving from a computer control signals that control a positioning module;
emitting from a nozzle comprised of an output aperture where such nozzle's position in three dimensions is determined by the positioning module, a material that cures in proximity to and exterior to the aperture while controlling the position of the nozzle in three dimensions in response to the control signals in order that the nozzle follows the set of curve paths so as to create formed curves that form the surface geometry out of the material.

12. The method of claim 11 where the emitting step is further comprised of:
positioning the nozzle so that at least two of the neighboring formed curves substantially touch along substantially their entire length.

13. The method of claim 11 further comprising:
receiving a first set of data to create a data structure in computer memory representing a 3D object with a surface geometry;
receiving a second set of data representing parameters defining the cross sectional dimension of a formed curve;
using the first set of data and the second set of data to generate a third set of data representing parameters defining the at least one curve paths that comprise the surface geometry;
using the third set of data to generate the control signals.

14. The method of claim 11 further comprising the step of:
Deriving parameters representing the curve paths from data defining the geometric surface.

15. The method of claim 11 further comprising:
mixing a first component and second component comprising the material so as to cause the material to cure as it is emitted, the first and second components selected so that they do not begin curing until mixed.

16. The method of claim 11 further comprising:
adjusting the position of a module housing the nozzle so that the module does not disturb previously formed curves while the nozzle's position is moved as it emits material.

17. The method of claim 11 where at least one start point associated with a corresponding at least one formed curves is on an irregular surface.

18. The method of claim 11 where at least one start point associated with a corresponding at least one formed curves is on a substantially vertical surface.

19. The method of claim 11 where at least one start point associated with a corresponding at least one formed curves is on the bottom of a substantially horizontal surface.

20. The method of claim 11 further comprising:
setting the nozzle to a state where it does not emit the material;
in dependence on the setting step, re-positioning the nozzle to a start point associated with the at least one curve paths;
in dependence on the re-positioning step, setting the nozzle to a state where it re-commences the emission of the material;
in dependence on the re-commencing step, controlling the position of the nozzle in order that it follows the at least one curve paths; and
upon the controlled position of the nozzle reaching the end-point of the at least one curve paths, setting the nozzle back to the state where it does not emit the material.

21. The method of claim 1 further comprising:
adjusting the speed of the positioning of the nozzle in order to control the cross sectional dimension of the formed curve.
